(19) United States
(12) Patent Application Publication
(10) Pub. No.: US 2013/0149422 A1
(43) Pub. Date: Jun. 13, 2013

(54) Animal Feed Processing Agents, Animal Feeds and Methods of Processing Animal Feed

(71) Applicant: PRO-CON INTERNATIONAL, LLC, Daisetta, TX (US)

(72) Inventor: Mark Owen Bublitz, South Slocan (CA)

(73) Assignee: PRO-CON INTERNATIONAL, LLC, Daisetta, TX (US)

(21) Appl. No.: 13/764,633

(22) Filed: Feb. 11, 2013

Related U.S. Application Data
(63) Continuation-in-part of application No. 12/657,939, filed on Jan. 28, 2010.
(60) Provisional application No. 61/167,337, filed on Apr. 7, 2009.

(51) Int. Cl. A23K 3/00

(52) U.S. Cl. CPC A23K 3/00
USPC 426/331; 426/623; 514/724

(57) ABSTRACT

Animal feed processing agents containing an azeotrope comprising water, an alcohol, and sodium stabilized by surrounding organized water. Methods of processing animal feed utilizing steam flaking in the presence of added agent comprising an alcohol, and sodium stabilized by surrounding organized water. An animal feed comprising an alcohol and sodium, wherein the grain of the feed is enriched in amylopectin, contains gelatinized starch, contains no added organic acids and is resistant to molds and fungi without added preservatives.

### RELATED PATENT DATA

This patent resulted from a Continuation-In-Part of U.S. application Ser. No. 12/657,939, filed Jan. 28, 2010 which is hereby incorporated by reference in its entirety.

### TECHNICAL FIELD

The present invention relates to methods of forming chemical agents for processing animal feeds, agents for stabilizing amines, agents for assisting in CO₂ capture, methods of processing animal feeds methods of stabilizing amines, methods of CO₂ capture and abatement, and systems for CO₂ removal from gas streams and gas emissions.

### BACKGROUND OF THE INVENTION

Animal feeds comprising grain are fed to livestock as a source of energy. Grain feeds can comprise one or more grains including but not limited to corn. The feed value of any feed depends upon nutrient content, intake and digestibility. Grain feeds are typically processed to enhance these factors. The pH of a feed is important for maintaining proper pH in the digestive tract. Steam rolling or flaking of grains rather than fine grinding are typically used to avoid metabolic diseases and to increase available starch.

Steam flaking is a process that exposes the grain to steam and/or hot water before passing through a set of rolls. Such treatment increases the digestibility of the grain in an animal's digestive tract. Total tract starch digestion increases as flake density decreases. However, the conventional processing methods can allow or enhance growth of molds and fungi. Further, steam flaking can be expensive. The increase in dietary feed efficiency must be at least 6% to make steam flaking cost effective. It would be useful to develop new feed processing methods.

Amine treatment plants utilize amine processing to treat gas streams such as natural gas streams and refinery streams for removal of contaminants such as CO₂ and H₂S. The CO₂ captured during the amine processing can often be collected for commercial use. The amine utilized for amine treatment is often one of monoethanolamine (MEA), methyldiethanolamine (MDEA) or diethanolamine (DEA). Other amines utilized include diglycolamine (DGA), diisopropanolamine (DIPA) and proprietary amine agents.

Amine treatment for CO₂ capture can also be used to remove CO₂ from combustion gases, flue gases and abatement of greenhouse gases.

Problems associated with amine treatment include corrosion that can occur when CO₂ reacts with water in the amine solution to form acids. Other problems include foaming in the system, degradation of the amine mixture to form acids, bases and salts, and hydrocarbon saturation of the amine mixture. Additional problems include the high cost of amine or amine mixtures and high cost of regeneration.

It would be advantageous to develop agents for decreasing or preventing some or all of the problems associated with amine treatment set forth above.

### SUMMARY OF THE INVENTION

The invention encompasses amine and alcohol stabilizing agents containing an azeotrope comprising alcohol and a sodium/water structure. The invention additionally encompasses amine stabilizing agents containing water and a liquid silica hydroxide compound. The invention additionally encompasses making of amine stabilizing agents. Solid silicon rock and sodium hydroxide are mixed with an ammonium/water solution to produce a green liquid in a first stage of the reaction. Alcohol is added and the alcohol fraction is separated from the non-alcohol fraction to produce an alcohol fraction product and a bottom fraction that is not soluble in alcohol or organics.

The alcohol fraction can be utilized during the processing of animal feeds during steam flaking.

The agents can be added to amines for stabilizing amines in amine processing of gases, in CO₂ capture, in CO₂ abatement systems and in other systems where amines are utilized to remove contaminants.

### BRIEF DESCRIPTION OF THE DRAWINGS

Preferred embodiments of the invention are described below with reference to the following accompanying drawings.

FIG. 1 is a flowchart diagram overview of methodology in accordance with one aspect of the invention.

FIG. 2 shows the reaction of the invention occurring during Reaction Stage I.

FIG. 3 shows the final product produced by Reaction Stage I of the invention.

FIG. 4 displays product separation in Reaction Stage II prior to removal of the uppermost fraction from the bottom fraction.

FIG. 5 shows a ²³Na NMR spectrum of the uppermost fraction product (alcohol soluble fraction) of the invention.

FIG. 6 shows a chart of groups identifiable by infra-red analysis superimposed upon an infrared scan chart (Panel A), and in Panel B, an FTIR spectra comparison of the base product of the invention after reaction stage 1 (dashed) compared to the polymeric species product (solid) disclosed by Merkl in U.S. Pat. No. 4,029,747 (see Merkl, FIG. 7).

FIG. 7 shows FTIR spectra comparisons of the base product after reaction stage 1 (dashed) compared to the monomeric species product (solid) disclosed by Merkl in U.S. Pat. No. 4,029,747 (see Merkl at FIG. 3).

FIG. 8 shows and SEM photograph of a liquid mass obtained by drying the green liquid solution at 250° C. for 24 hours.

### DETAILED DESCRIPTION OF THE PREFERRED EMBODIMENTS

In general, the invention encompasses agents utilized in processing animal feed, agents that stabilize amines in solution, methods of forming the agents and methods of utilizing the agents. The agents of the invention are useful in systems where amine treatment is utilized for removal of CO₂ and/or H₂S. More specifically, the agents can be utilized for treatment of natural gas, liquid petroleum gas, combustion gas, flue gases, etc. The agents of the invention can also be utilized for CO₂ capture to produce CO₂ for commercial use. The agents of the invention can additionally be utilized to stabilize amines in solution, including DNA. The agents can additionally be cost effectively utilized during steam flaking of animal feeds.

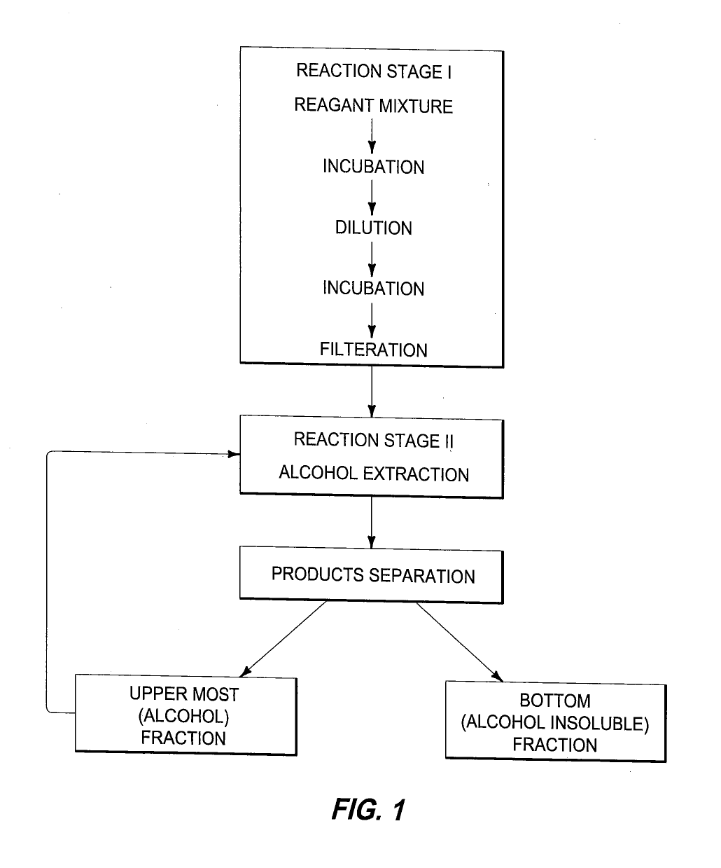

Methods of producing agents of the invention are described generally with reference to FIGS. 1-4. Referring initially to FIG. 1, a reagent mixture is formed. An open reaction vessel is provided. Solid silicon in the form of silicon rock is added to the vessel. The size of the silicon rock utilized will be dependent upon the size of the reaction vessel as such affects the heating of the reaction. In a 35 gallon reaction, the average rock size should be about 2 inches diameter and larger. For a 300 gallon reaction, the average rock size should be 4 inches diameter and larger. 98% purity silicon metal may be utilized.

Solid NaOH is added in the form of flakes, pellets or prills. An appropriate ratio of silicon rock to NaOH can be from about 2:1 to about 5:12, by volume. While mixing quickly, a first water-ammonium solution is added to a final concentration of two parts water to one part NaOH, by volume, to form a mixture. The first water ammonium solution contains 5% ammonium hydroxide, mole weight. The ammonium solution is utilized to maintain the reaction temperature at or below 195° F. The addition of ammonium to the mixture introduces free hydrogen, free electron presence and controls heat dissociation of water/sodium hydroxide.

In preferred embodiments a catalyst can be utilized. Appropriate catalysts include, for example, Fe—Ni catalysts and Raney nickel. Where an iron-nickel catalyst is utilized an example catalyst can be 2 grams of iron/nickel oxide per gallon.

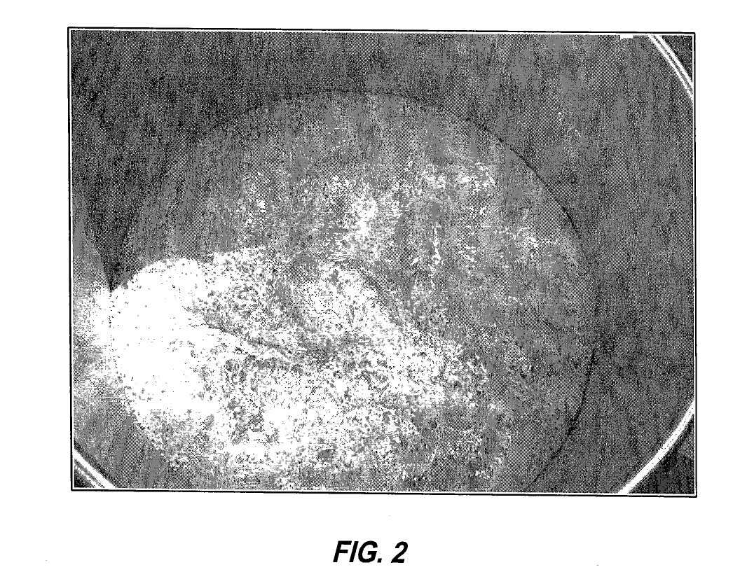

The reaction mixture is allowed to react for a one to two hour incubation period. At about 30 minutes, the reaction will begin to fizz. At about 145° F., the reaction appears to boil. The reaction mixture is very viscous and appears as shown in FIG. 2.

After reacting from about one to two hours, a second water-ammonium solution is added in small aliquots. The second ammonium solution contains 10% ammonium hydroxide, mole weight. The amount of solution added is the minimum sufficient to maintain the temperature of the reaction mixture at or below 195° F. Addition of too much water will kill the reaction. Water-ammonium addition is discontinued upon reaching a four to one ratio of water to sodium hydroxide.

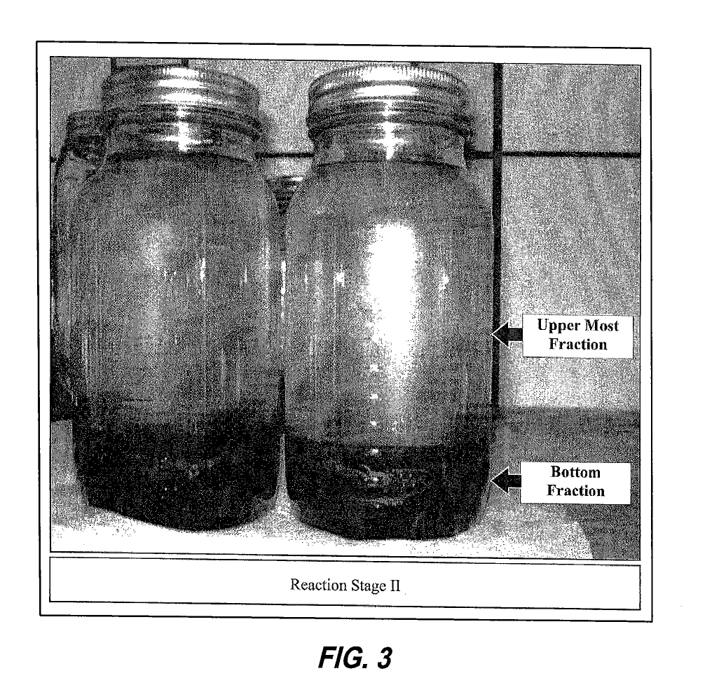

The reaction mixture is allowed to continue to react for from about six to about 8 hours. Upon completion, the reaction mixture will discontinue foaming and be grey/green in appearance as shown in FIG. 3, and has a pH of greater than 14. Water is then added to dilute the mixture and to bring the mixture to a final density of about 1.3 specific gravity. The mixture is allowed to stand for a period of about 24 hours.

After standing, the reaction mixture is filtered to remove the remaining silicon rocks. The filtered product is a green liquid as shown in FIG. 3.

In prior art reference U.S. Pat. No. 4,029,747, issued to Merkl on Jun. 14, 1977, non-alkaline metal was reacted with an alkali metal hydroxide in the presence of aqueous ammonium. In the Merkl reference, the products were a monomeric metal amide complex and an inorganic polymeric complex. The products of the Merkl reference were analyzed by FTIR. The green base product after stage I of the present invention was analyzed by FTIR and a comparison was made to the FTIR spectra presented in Merkl to distinguish the resulting product from that disclosed by Merkl.

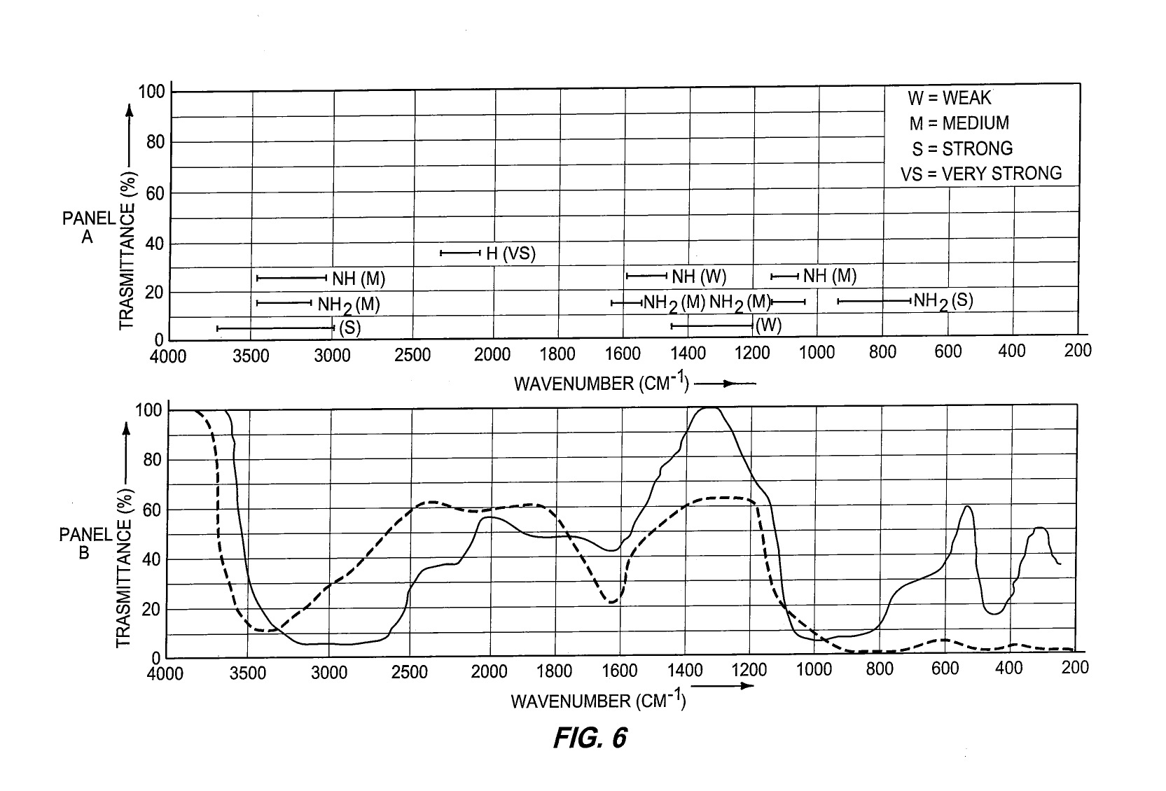

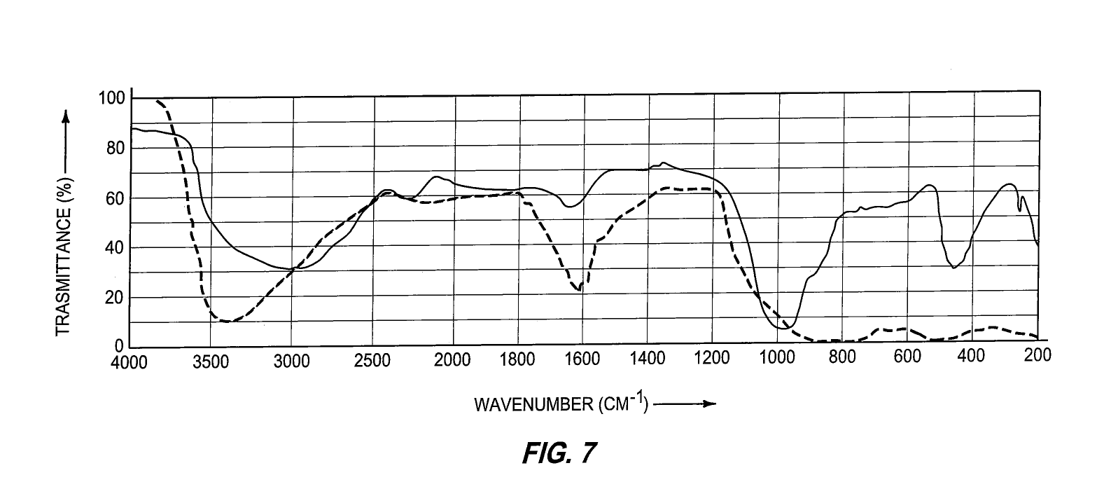

Referring to FIG. 6, such shows a comparison of the FTIR spectrum of the polymeric product of Merkyl (Si—Na liquid system after exothermic phase of reaction) shown in solid, and the FTIR spectrum of the stage I product of the invention, shown in dashed. In FIG. 7, the FTIR spectrum of the stage I product (dashed) is compared to the monomeric product disclosed in Merkl (solid). The comparison confirms that the product of the invention is not the metal amide complex or polymeric complex formed utilizing the methodology disclosed in the Merkyl patent.

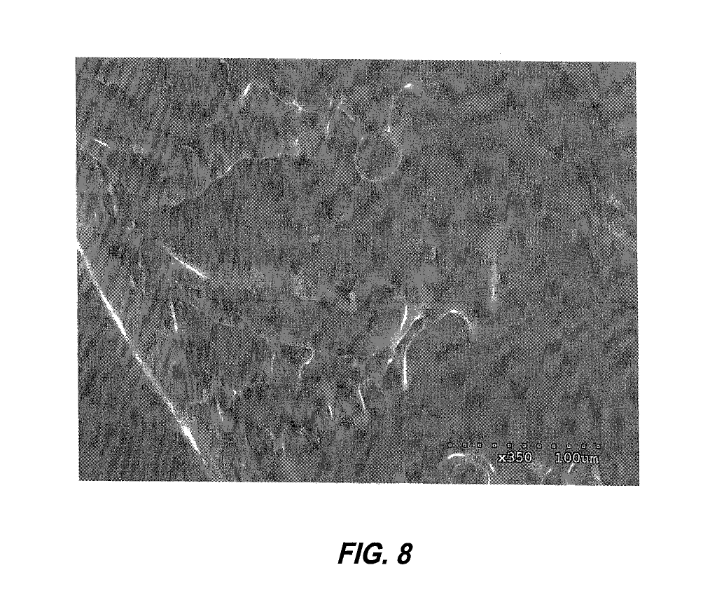

FIG. 8 is an SEM picture of the liquid mass obtained after drying the green liquid at 250° C. for 24 hours.

As shown in FIG. 1, the resulting green liquid is mixed with an alcohol. Alternative volumes of alcohol may be utilized to produce varying product concentration in the alcohol fraction (see below). The volume of alcohol can be from about 10% to about 90%, preferably from about 33% to about 66% of the final alcohol mixture. In particular instances, it can be preferred to add a 50% final volume of alcohol to the green liquid.

The alcohol is not limited to a particular alcohol. In preferred aspects the alcohol can be selected from methanol, ethanol and isopropanol, most preferably ethanol. The resulting mixture is mixed vigorously for five minutes and allowed to stand for at least 24 hours.

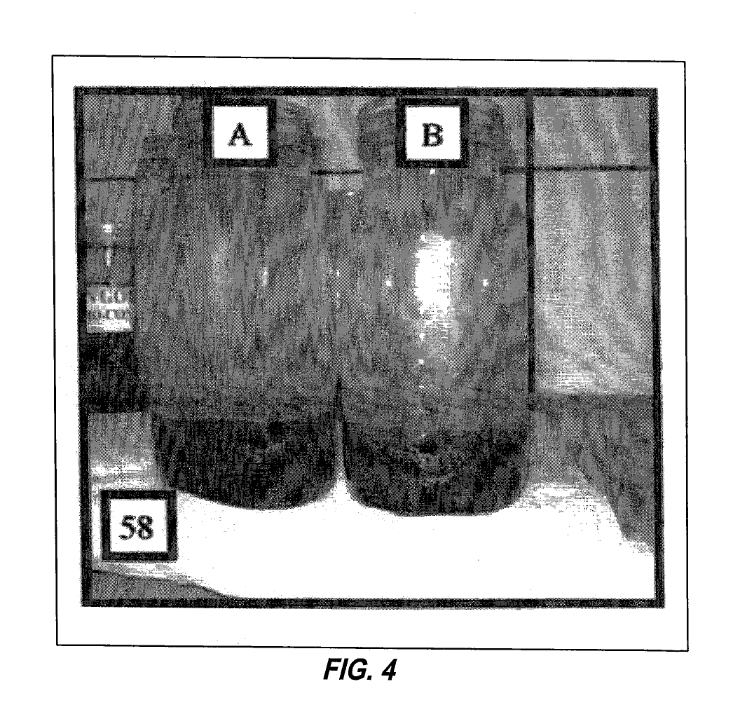

Upon standing, the mixture visibly separates into two distinct product fractions as shown in FIG. 4. 50% of the green liquid is solubilized in alcohol and is present in the upper fraction while 50% is insoluble in alcohol. The uppermost fraction is clear and yellow in appearance with a pH of at least about 13.5, while the bottom fraction (heel) is black and viscous with a pH of greater than or equal to 14. The bottom fraction is insoluble in alcohol.

The two fractions are separated from one another and each are collected as a raw product. The uppermost fraction is filtered.

Each of the uppermost fraction product and bottom fraction product can be utilized to treat fluids for CO₂ removal. The product is added to an amine to form an amine mixture and the amine mixture is utilized to contact a fluid that contains CO₂ to be removed. The fluid can be a gas stream or an emission. The contacting allows CO₂ absorption. Regeneration processing, typically by heating, is conducted to release the CO₂ and regenerate the amine.

Considering first the uppermost (alcohol) fraction, such product contains a sodium species that is contained within liquid water crystals. Alternatively described, the product is an electromagnetic liquid water crystal containing a organized water stabilized sodium, surrounded by an alcohol/water mixture.

Repeated alcohol extraction (Stage II) can be performed as indicated in FIG. 1. The uppermost fraction can be added to the green liquid again to create a two-solution mixture separated based upon density. The bottom layer contains a high silicon and sodium content as the upper layer contains only sodium with a small amount of silicon. By continuously adding uppermost fraction product to the green liquid, the upper layer will eventually contain less ethanol but more sodium-water structure. The density of the two layers eventually becomes equal and separation between layers is no longer visible.

Once density has equalized, the fraction can be cooled to −30° C. and then warmed back up to room temperature. Such processing served to separate all hydrogen bond connections. This process can be repeated until no separation is visible. After continuous cooling and warming, and separating the top liquid from the heel, the top liquid and the heel were each analyzed. The heel consistently showed high sodium and silicon content in a 1-1 mole ratio. The top liquid fraction shows a very low silicon to sodium ratio such that only a minute amount of silicon remains.

After repeated rounds of stage II processing, the resulting alcohol-containing product consists essentially of alcohol, water and sodium surrounded by stabilizing water molecules. The repetition of Stage II can concentrate the sodium/water structure and lower the alcohol content to create a more direct-use product. As the amount of alcohol decreases, separation between layers is eliminated. The stage II processing can be repeated two or more times, and can preferably be repeated up to six times. The final product typically has an alcohol content of 6-9%, by volume.

Analysis of the upper fraction after repeated extraction indicates an ethanol-water solution with a specific gravity of greater than 1.00, a pH of about 14, viscosity of 20 w oil, with sodium as the only major element in the liquid. An example sample contained 10,000mg/L sodium in 9% ethanol, 91% water. The resulting heel had 110,000 mg/L silicon and 110,000 mg/L sodium. Repeated samples also indicate about equal amounts wt/wt of silicon and sodium in the heel.

The alcohol fraction is an azeotrope having a boiling point of about 80.5° C., above that of ethanol and lower than that of water. The water-stabilized sodium structure is an important part of this ternary azeotrope, affecting the boiling point of the alcohol fraction. The presence of the sodium structure also affects hydrogen bond strengths and lengths.

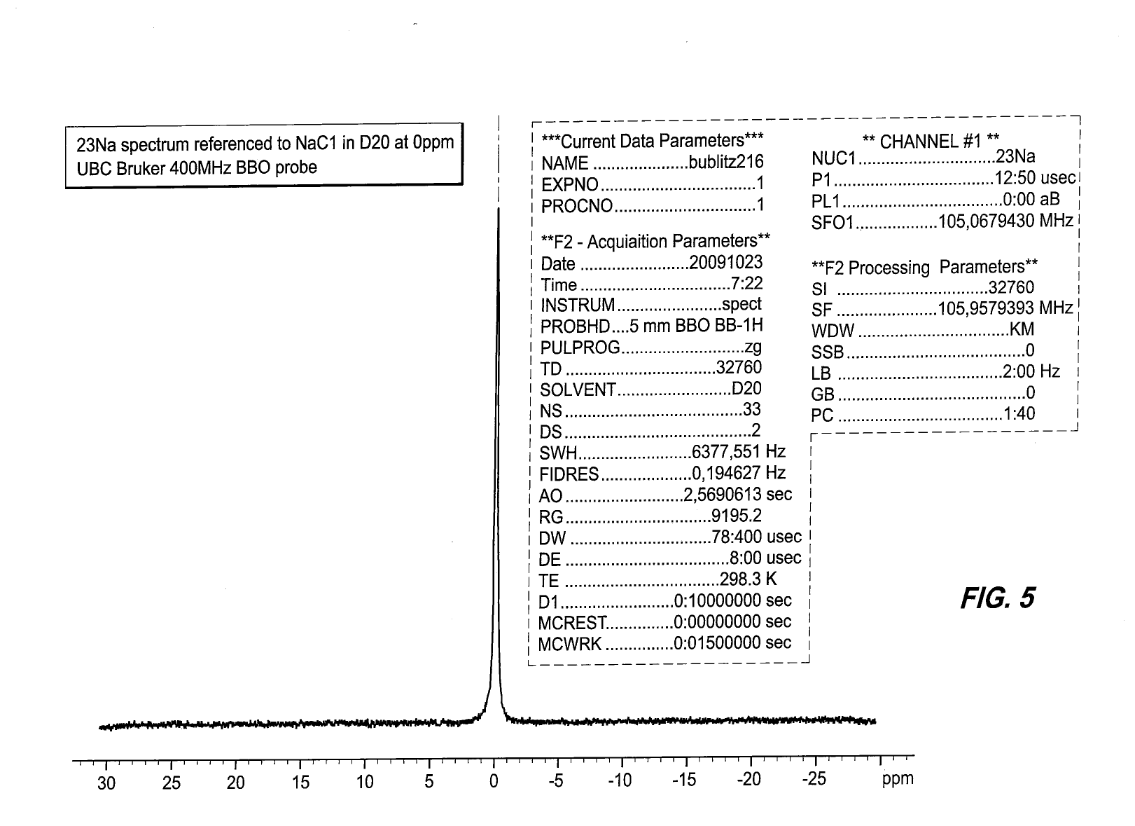

The alcohol/sodium product was analyzed by nuclear magnetic resonance (NMR) spectroscopy ²³Na. As shown in FIG. 5, the ²³Na NMR spectrum has a single spike, indicative of a single sodium species product. It has been assumed that this is a cationic sodium similar to the sodium in sodium chloride. Accordingly, hydrated electrons must be involved in the structure due to the high basicity of the product liquid. It is theorized that this is where the electromagnetic charge originates and stabilizes the liquid structure.

Elemental analysis of the concentrated product after first round of alcohol extraction was conducted. The results are presented in Table I.

TABLE I
Elemental Analysis by ICP-MS analysis

| Lithium (Li) | <0.5 | μg/L |
|---|---|---|
| Beryllium (Be) | <0.05 | μg/L |
| Boron (B) | <0.5 | μg/L |
| Sodium (Na) | 3073 | mg/L |
| Magnesium (Mg) | <0.003 | Mg/L |
| Aluminum (Al) | 0.15 | mg/L |
| Silicon (Si) | 74.5 | mg/L |
| Phosphorous (P) | 0.07 | mg/L |
| Sulfur (S) | 15.8 | mg/L |
| Chloride (Cl) | — | |
| Potassium (K) | 11.6 | mg/L |
| Calcium (Ca) | 0.03 | mg/L |
| Titanium (Ti) | <0.1 | μg/L |
| Vanadium (V) | 20 | μg/L |
| Chromium (Cr) | <0.7 | μg/L |
| Manganese (Mn) | <1.0 | μg/L |
| Iron (Fe) | 0.005 | mg/L |
| Cobalt (Co) | 2.0 | μg/L |
| Nickel (Ni) | <10.0 | μg/L |
| Copper (Cu) | 43.6 | μg/L |
| Zinc (Zn) | 5.0 | μg/L |
| Arsenic (As) | <1.0 | μg/L |
| Selenium (Se) | <7.0 | μg/L |
| Strontium (Sr) | <4.0 | μg/L |
| Molybdenum (Mo) | 40 | μg/L |
| Silver (Ag) | <1.0 | μg/L |
| Cadmium (Cd) | <0.5 | μg/L |
| Tin (Sn) | — | |
| Antimony (Sb) | — | |
| Barium (Ba) | — | |
| Mercury (Hg) | — | |
| Thallium (T) | — | |
| Lead (Pb) | <8.0 | μg/L |

| | |
|---|---|
| Bismuth (Bi) | — |
| Thorium (Th) | — |
| Uranium (U) | — |

After six rounds of stage II extraction, the resulting silicon concentration can be less than 100 mg/L, preferably less than 50 mg/L. It is noted that metals are concentrated in the alcohol fraction while silicon is separated out into the bottom fraction thereby significantly reducing the silicon present in the concentrated final product.

In the purified ethanol product, there exists a sodium water (solvated electron) structure and/or ether-sodium structures and carries an electromagnetic charge (−350 mv) due to its electron rich formation. The electromagnetic liquid has proven to affect internal dispersion forces, weaken the electronegativity of oxygen, affect bonding of lone pairs of electrons, and affects hydrogen bonding in water, alcohols, and amines. During the dissociation reaction in processing to produce the concentrated product, Na+ ions are believed to create broken hydrogen bonds during a high aqueous density. Interactions between water and Na+ are stronger than those between water molecules.

The inert lone pair effect is believed to pay an important role in the properties of the concentrated alcohol product. The inert lone pair effect allows electrons to remain non-ionized, or unshared in compounds, high basicity with lone pair availability. Lone pair effect increases stability of oxidation state, adjusts electronegativity, avoids protonation, in turn avoiding corrosion, realigning dispersion forces of oxygen and nitrogen and creating balance to prevent redox in a corrosive direction.

Basic physical properties of the alcohol/sodium product of the invention are set forth in Table II

TABLE II

| Property | Method Used | Results | Unit |
|---|---|---|---|
| pH | ASTM D6423 | 13.5 | ph |
| Density @ 15° C. | ASTM D4052 | 909.4 | Kg/m³ |
| Kinematic Viscosity | ASTM D445 | 2.65 | cSt |
| @ 25° C. | | | |
| Freezing point | ASTM D5972 | −43.7 | ° C. |
| Boiling point | ASTM D86 | 79.5 (IBP) | ° C. |
| | | 80.9 (FBP) | ° C. |
| Vapor Pressure, | ASTMD5191 | 38.1 | kPa |
| DVPE | | | |
| Flash Point | ASTM D3828 | 20.0 | ° C. |
| Heat of combustion | ASTM D4809 | 17.322 | MJ/kg |
| (gross) @ 25° C. | | | |
| Water content by | ASTM E1064 | 45.289 | Mass % |
| Coulometric Karl | | | |
| Fischer titration | | | |
| Existent gum content | ASTM D381 | 1152.0 | mg/100 mL |
| Lubricity by high | ASTM D6079 | 0.84 major axis | mm |
| frequency | | 0.84 minor axis | mm |
| reciprocating rig | | | |
| (HFRR) Wear scar | | | |
| diameter @ 25° C. | | | |
| Copper corrosion | ASTM D130 | 1b | |

One use of the concentrated alcohol fraction product is in the processing of animal feeds. The animal feed stock to be treated can comprise one or more grains including but not limited to corn. Feed processing in accordance with the invention can comprise addition of the concentrated alcohol product described above as a processing agent during a steam flaking process. The agent can be added to water or steam at approximately 32 oz per treated ton of feed. Addition of the agent can be prior to entry into the processing system, can be entered into the steam flow prior to contact with the grain feed, or can be administered to the how water bath in the process system.

The surfactant properties of the processing agent allow reduction of surface tension and high absorption of moisture faster and more readily than traditional flaking processes. Additionally, the high pH of the agent helps break down the waxy coating on grains to facilitate moisture penetration. The water absorption swells the grain forming gels. Swollen grain become enriched in amylopectin as amylose diffuses out. Swelling lowers the density which increases starch digestibility.

Most traditional wetting agents added during steam flaking of animal feeds contain volatile organic acids (e.g. propionic acid). These agents are corrosive to the processing equipment. Further, acids present in processed feeds can be disruptive to animal digestive systems. Additionally, these volatile acid agents can be released into the environment. The product of the invention is non-corrosive and can be utilized more cost effectively than acidic agents such as propionic acid. Further, the processing agent of the invention is basic and is non-disruptive to digestive tracts.

The high electron presence of the concentrated alcohol product can act as a preservative to feed by inhibiting growth of molds and fungi.

The feed processing agent (concentrated alcohol product) of the invention can utilize less steam energy per ton of feedstock and produce more gelatination of starch in less time than traditional methods. Use of this processing agent increases starch energy value in the feed and lowers feed flake density thereby enhancing the efficiency of animal growth per unit of grain fed.

The alcohol present in the processing agent adds sweetness to the processed feed thereby adding aroma and improving palatability.

Another use of the alcohol/sodium product is in amine stabilization. The concentrated product can be characterized by a number of factors that play a role in amine stabilization. The product is characterized by hydration of isolated monovalent sodium ions in an aqueous solution. The sodium ions are not fixed in position and are not attached to ions of the opposite charge. The water of the product is dipole stabilized. The high basicity is due to relief of strain on protonation and strong internal hydrogen bonding. High dipole stabilization exists similar to morpholines and piperzines. There exist electrostatic interaction energies from dipole movements in ammonia and amines that correlate with hydrogen bond basicity and restructuring of water into small clusters which relieve surface tension.

Although not intending to be bound by theory, it is theorized that the stabilization of amines and hydrogen bonds in general is due to the product's ability to prevent abstraction of hydrogen from a hydrogen bond. Regardless, the ability of the product to stabilize amines and strengthen hydrogen bonds in general is important to the mechanisms of corrosion prevention, oxidation, and interfacial surface tension dynamics.

The concentrated sodium/water fraction can be utilized as a more direct use product than the product prior to repeated rounds of Stage II treatment. It is also easier to administer and can be utilized for more applications than the initial uppermost fraction. Additionally, smaller quantities of the concentrated product can be utilized, making it easier to administer, store and transport. When the purified alcohol fraction is added to primary or secondary amines the alcohol fraction creates a stable solution with little or no surface tension. The alcohol product of the invention has the effect of strengthening hydrogen bonds and decreasing the number of hydrogen bonds to stabilize the amine. There is a resulting decrease in vapor pressure and a higher boiling point than either the amine or the alcohol fraction. This is supported by pKa readings of the resulting amine/product mixture.

These factors make the sodium/water product ideal for utilization for amine stabilization in amine processing during gas treatment and fuel creation. In gas treatment, the concentrated water/amine product is added to the water preferably prior to blending with the amine to avoid any acid/base shock reaction, especially in the case of a large amount of water/amine mixture being added to the gas treatment facility system as a total change out or conversion.

The concentrated sodium/water product can be added to the water portion of a water/amine mixture to a final concentration of about 1-5%. Alternatively 1-5% by volume of the concentrated sodium/water product can be added to the amine directly. The percentage can be determined by the amine structure and the internal charge needed to stabilize the amine. The stabilization of amines utilizing the alcohol product of the invention additionally reduces the temperatures at which regeneration can occur thereby lowering the expense of amine regeneration.

The basicity of the alcohol fraction product can play an important role during gas processing and CO₂ capture. The basicity prevents acidic protons from being present in the system. Acidic protons present during amine treatment play a role in corrosion, foaming, hydrocarbon saturation, oxygen-salt degradation and product loss; and affects loading and CO₂ release during regeneration. The basicity inhibits formation of acid forming compounds, increases loading capabilities, controls deprotonation of zwitterions reactions, is repulsive to oxygen and sulfur compounds, and effects the temperature of absorption by changing the absorber bulge and maintaining lower temperatures (latent heat).

Considering the concentrated sodium/water product, the trace silicon content and low ethanol level, the product is a nucleophilic catalyst due to the high percentage of water. The product can be diluted up to tenfold and retain enough sodium crystal to maintain a pH above 11.5.

The product's ability to reduce surface tension is also important during gas treatment and CO₂ capture. The lower the surface tension the better the contact for absorption. Lower surface tension also produces lower corrosion of metals, lower energy costs in pumping and regeneration, inhibits hydrocarbon saturation in amine mixture, eases water amine separation in regeneration reflux (to prevent amine carryover into reflux water), and inhibits water from exiting with CO₂ to create a dry CO₂ stream.

The alcohol fraction or sodium/water fraction has the ability to prevent solubility of hydrocarbons, thus decreasing hydrocarbon saturation during amine treatment of gases (during amine processing or CO₂ capture), which in turn decreases hydrocarbon losses.

The concentrated product can be added in small to large amounts to hydrogen peroxide and raise the pH to 8.5 or higher without destabilizing the oxygen for uses in oxidative desulphurization of all hydrocarbon structures.

Tests of the alcohol fraction product were performed utilizing an amine treatment facility. The tests indicated reduced foaming, decreased corrosion within the system, less oxidation and degradation of the amine, with less polymerization and formation of heat-stable salts, and dry CO₂ product stream.

The alcohol fraction or diluted form thereof, may be added to any existing amine absorption process without altering any part of the operation structure. Loading and amine concentrations can be increased. The results include decreased foaming, a significant decrease in process energy utilization and decreased product losses. Thus, the alcohol product is useful for treatment of natural gas, liquid petroleum gas and flue gases with lower amine loss, lower degradation, decreased foaming, decreased corrosion and decreased hydrocarbon saturation. These results allow cost savings due to the ability to utilize lower cost amines, the use of decreased or no de-foamers, fewer corrosion inhibiters and longer life of the system, and no need for carbon filters.

Additional advantages afforded with the use of the alcohol fraction product in amine treatment systems include: the ability to use smaller operating facilities due to the ability to utilize increased amine concentration and higher loading; decreased energy usage due to lower heat of dissociation during regeneration; no need for expensive additives; amine life expectancy increased a minimum of tenfold; and CO₂ recovery cost reduction of 300% over competitive products without changing existing operational profile.

The alcohol fraction of the invention can be especially useful for CO₂ capture due to its ability to produce a dry CO₂ product stream, as well as its additional properties set forth above. Table III shows current and emerging solvents utilized for CO₂ capture and costs thereof. As shown, the product of the invention (alcohol/sodium product) is economical and efficient.

TABLE III
Current and emerging solvents for CO₂ capture

| | | | | Solvent | |
|---|---|---|---|---|---|
| | | Solvent | Solvent | Cost | Steam Use |
| | | loss (kg/ | Cost | ($/ton | (ton/ton |
| | Solvent | tonCO₂) | ($/kg) | CO₂) | CO₂) |
| Non- | MEA | 1 to 3 | 1.30 | 1.3 to 3.9 | 2.0 |
| proprietary | | | | | |
| Econamine¹ | MEA + | 1.6 | 1.53 | 2.45 | 2.3 |
| | inhibitors | | | | |
| KS-1² | Hindered | 0.35 | 5.00 | 1.75 | 1.5 |
| | amines | | | | |
| PSR³ | Amine mix | 0.1 to 0.9 | — | — | 1.1 to 1.7 |
| Praxair⁴ | Amine mix | 0.5 to 1.5 | 2.00 | 1 to 3 | 1.3 to 1.5 |
| Sodium/ | Amine mix | 0.1 to 0.2 | 2.80 | 0.35 | 1.1 to 1.3 |
| water | | | | | |
| product | | | | | |

¹Econamine ™, Fluor Corp. 6700 Las Colinas Blvd. Irving TX 75039.
²KS-1 ®, Mitsubishi Heavy Industries, Ltd. Konan 2-chome, Minato-ku Tokyo JAPAN 108-2815.
³PSR ™, Amit Chakma.
⁴Praxair ®, Praxair Technology, Inc. 39 Old Ridgebury Rd. Danbury CT 06810

The sodium/water fraction is also useful in amine-based absorption of CO₂ post combustion from power plant or other emissions (CO₂ abatement). The water/sodium fraction product can be added in place of water in existing amine circulation systems. The result is reduced foaming, decreased corrosion, decreased hydrocarbon saturation and decreased amine degradation. The alcohol fraction or sodium/water product can be utilized in low-pressure, high carbon dioxide streams with an appropriate amine. Types of gases treated may include but are not limited to liquid petroleum gas, natural gas, coal combustion gas, natural gas combustion gas, diesel combustion gas and oil well flare gas.

In one aspect, the concentrated alcohol product can be utilized in concentrated form. In another aspect, the alcohol fraction can be diluted with water prior to use. In another aspect the alcohol fraction or diluted form thereof, can have an appropriate amine or amine mixture added prior to use. Appropriate amines include, for example, MEA, MDEA, DEA, DGA, DTPA, and mixtures thereof. Polypropylene glycol can optionally be added to the mixtures to increase water solubility. Sulfolane can be added to assist in the removal of mercaptans and other sulfur species. It is noted that since the product stabilizes amines and allows easier regeneration, lower cost amines may be utilized in conjunction with the product of the invention.

One example mixture that may be utilized is a mixture of the alcohol fraction (concentrated) with MEA. Uses include, inter alia, utilization as a CO₂ scavenger. For example, this product mixture can be utilized in small production gas wells and main gas transportation lines to lower CO₂ levels. The product mixture can remove up to two moles of CO₂ per mole of product mixture. The product mixture additionally reduces system corrosion (see below).

Another example mixture that can be utilized is 50% concentrated alcohol fraction mixed with 50% triazine. This product mixture can be utilized as an H₂S scavenging liquid. The mixture has a pH of at least 14 with H₂S loading capabilities of up to 4 pounds per gallon of mixture (double the capacity of 100% triazine). The product mixture has a freeze point of below −40° F. which avoids the need to winterize process systems with methanol. This product mixture can be utilized in static mixer designed process systems. The product replaces Sulphatreat® (M-I L.L.C. 5950 North Course Drive, Houston Tex. 77022) and other similar scavenging products that are more expensive.

Considering now the bottom (alcohol insoluble) fraction, such comprises a silica hydroxide liquid compound (at room temperature). The bottom fraction, although insoluble in alcohol an organic solvent, is water-soluble. The silica hydroxide-containing bottom fraction can also be utilized to stabilize amines.

Table IV Shows a chemical comparison structure between a normal sodium hydroxide liquid to the concentrated sodium/water fraction after repeated stage II processing.

TABLE IV

| | Liquid sodium hydroxide | Concentrated |
|---|---|---|
| | 50% NAOH 50% water | water/sodium |
| Boiling point | 4.4° C./40° F. | O° C./32° F. |
| pH | 13.7 | 13.5 |
| S.G. | 1.53 | 1.04 |
| Corrosivity | Highly Corrosive | Non-Corrosive |
| Sodium content | 500,000 mg/L sodium | 10,000 mg/L sodium |
| Stability | Highly reactive | Non-reactive |
| | High hydroxide content | High hydrogen content |

Similar to the alcohol fraction, the sodium/water fraction can be utilized by addition to amine absorption facilities, mixed with an amine, to treat flue gases, natural gas, liquid petroleum gas, etc. Again, the amine may be a low cost amine due to the stabilization afforded by the product. The use of the product results in lower amine loss, decreased degradation, decreased foaming, decreased corrosion, decreased hydrocarbon saturation and increased cost savings relative to alternative amine treatment systems.

The properties of the sodium/water in a CO₂ capture system include enhanced loading capabilities, higher pH, ease of absorption/desorption which in turn decreases energy requirements, improved product purity (water free CO₂), increased amine/water solubility and lower amine loss due to carry over or degradation.

The bottom fraction can additionally be utilized as a scrubbing liquid that can be added to water circulation-spray systems in wet scrubbers to remove contaminants from gas streams. The bottom fraction containing liquid silica hydroxide compound can replace troublesome caustic sodas and solid lime with less expense and higher efficiency. The use of this product decreases or avoids process system corrosion by chemically neutralizing the wet scrubbing environment.

In the scrubbing application, small amounts of hydrogen peroxide, sodium hypochlorite and/or ammonium hydroxide can be added to the bottom fraction product to improve activity without affecting the structure of the product.

It is important to note that, in contrast to traditional lime or calcium hydroxide scrubber additives, the present product does not produce gypsum as a byproduct. The byproduct produced utilizing the bottom fraction in scrubbing processes is a nitride/sulfide-based solid that may be utilized for fertilizers. Corrosion in the scrubbing system is decreased or eliminated thereby extending the life of the system components.

The bottom fraction, when added to a scrubbing system, provides an electrostatic environment. The product hinders the formation of acids (such as H₂SO₄) that typically occurs in the wet environment of scrubbing processes. This hindrance is due to the product's ability to affect dispersion forces of non-bonding lone pairs of electrons involved in hydrogen bonding, such as occur in nitrogen, oxygen, sulfur and halogen species. In the presence of the product, high base salts (responsible for degradation) and acids (responsible for corrosion) will be reduced or eliminated.

In another aspect, the bottom fraction can be utilized as part of a mixture in soil washing applications. The mixture can contain from 5% to 50% bottom fraction as an “activator”. The mixture can further contain from 20% to 50% of a catalyst such as H₂O₂, with any balance being water. The resulting mixture is environmentally safe and can be utilized to destroy harmful hydrocarbon structures from soils and/or water sources.

The methodology for hydrocarbon destruction from soils comprises soaking the soil in the above-described mixture and allowing the mixture to evaporate.

This product mixture can additionally be utilized for creation of hydrogen gas, pressure and heat for down-hole enhancement or oil/sand separation without external heat. The amount of heat and pressure will depend upon the peroxide/bottom fraction ratio.

The invention claimed is:

1. A method of processing animal feed, comprising;
providing a feed stock comprising one or more grains;
adding a processing agent comprising alcohol and sodium stabilized by surrounding organized water molecules; and
steam flaking the feed stock in the presence of the agent.

2. The method of claim 1 wherein the alcohol is present at a content of from about 6% to about 9%, by volume.

3. The method of claim 1 wherein the agent has a silicon content of less than about 100 mg/L

4. The method of claim 1 wherein the alcohol is ethanol.

5. The method of claim 1 wherein the steam flaking in the presence of the processing agent produces a gel.

6. The method of claim 1 wherein the method of processing feed increases the energy value, digestability and palatability of the feed.

7. The method of claim 1 wherein the processing agent has surfactant properties which increase moisture absorption during the processing.

8. The method of claim 1 wherein the processing agent inhibits growth of molds and fungus.

9. An animal feed comprising:
one or more grain types;
ethanol;
sodium; and
wherein the grain is enriched in amylopectin, contains gelatinized starch, contains no added organic acids and is resistant to molds and fungi without added preservatives.

10. The animal feed of claim 9 comprising corn.

11. An agent for processing animal feed, comprising:
alcohol at a content of from about 6% to about 9%, by volume;
silicon; and
sodium stabilized by surrounding organized water molecules.

12. The agent of claim 11 wherein the alcohol content is from 6% to 9%, by volume.

13. The agent of claim 11 wherein the alcohol is ethanol.

14. The agent of claim 11 wherein application of the agent to animal feed comprising grain in the presence of water induces moisture uptake and swelling of the grain.

15. The agent of claim 11 wherein application of the agent to animal feed inhibits growth of molds and fungi.
